(19) United States
(12) Patent Application Publication
(10) Pub. No.: US 2025/0111809 A1
(43) Pub. Date: Apr. 3, 2025

(54) DISPLAY DEVICE, DISPLAY METHOD, AND RECORDING MEDIUM

(71) Applicant: Panasonic Automotive Systems Co., Ltd., Kanagawa (JP)

(72) Inventors: Masanaga TSUJI, Osaka (JP); Toshiya MORI, Osaka (JP)

(73) Assignee: Panasonic Automotive Systems Co., Ltd., Kanagawa (JP)

(21) Appl. No.: 18/795,466

(22) Filed: Aug. 6, 2024

(30) Foreign Application Priority Data
Sep. 29, 2023 (JP) 2023-170156

(51) Int. Cl. G09G 3/00

(52) U.S. Cl. CPC G09G 3/001; G09G 2320/0613; G09G 2340/0464; G09G 2380/10

(57) ABSTRACT

A display device includes: a controller that determines at least one content to be displayed in association with a target object that is present in a forward view of a vehicle; and a display that displays the at least one content as a virtual image through a display medium provided in the vehicle by projecting, onto the display medium, light that represents the at least one content determined by the controller. The controller adjusts, for each of the at least one content, a correction amount relating to a placement position of the content.

### CROSS REFERENCE TO RELATED APPLICATION

The present application is based on and claims priority of Japanese Patent Application No. 2023-170156 filed on Sep. 29, 2023.

### FIELD

The present disclosure relates to a display device, a display method, and a non-transitory computer-readable recording medium having recorded thereon a program.

### BACKGROUND

Conventionally, in-vehicle head-up displays (HUDs) are known as display devices. Of the HUDs, displays capable of displaying a virtual image overlaid on the actual view are particularly called augmented reality head-up displays (AR-HUDs). In an AR-HUD, a misalignment occurs between a virtual image displayed by the AR-HUD and the actual view, due to a change in the attitude angle of a vehicle that is traveling.

For example, Patent Literature (PTL) 1 discloses a display control device including a correction amount preparer and a display controller. The correction amount preparer prepares a correction amount used to correct a misalignment of the display position of a content to be overlaid in association with a target object which is present in the forward view of the vehicle and onto which the content is overlaid, where the misalignment is a misalignment relative to the target object. The display controller overlays the content onto the target object and reduces the misalignment of the content relative to the target object through correction processing, using the correction amount.

### CITATION LIST

### Patent Literature

PTL 1: WO 2021/044741

### SUMMARY

However, the display control device disclosed in PTL 1 can be improved upon.

In view of this, the present disclosure provides a display device and so forth capable of improving upon the above related art.

The display device according to an aspect of the present disclosure includes: a controller that determines at least one content to be displayed in association with a target object that is present in a forward view of a vehicle; and a display that displays the at least one content as a virtual image through a display medium provided in the vehicle by projecting, onto the display medium, light that represents the at least one content determined by the controller, wherein the controller adjusts, for each of the at least one content, a correction amount relating to a placement position of the content.

The display device and so forth according to an aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing the vehicle chamber of a vehicle in which a display device according to an embodiment is disposed.

FIG. 2 is a block diagram showing the vehicle.

FIG. 3 is a diagram showing contents to be projected in a display region and correctable correction amounts of the contents.

FIG. 4 is a diagram showing a first content projected in the display region and correctable correction amounts that are responsive to the placement position of the first content.

FIG. 5 is a diagram showing a second content projected in the display region and correctable correction amounts that are responsive to the placement position of the second content.

FIG. 6 is a diagram showing a third content projected in the display region and correctable correction amounts that are responsive to the placement position of the third content.

FIG. 7A is a diagram showing a fourth content projected in the display region and correctable correction amounts that are responsive to the placement position of the fourth content.

FIG. 7B is a diagram showing fourth content projected in the display region and the correctable correction amounts that are responsive to the placement position of the fourth content, when the vehicle is traveling at a low speed and at a high speed.

FIG. 8 is a diagram showing a manner in which the orientations of contents projected in the display region are changed.

FIG. 9 is a diagram showing contents and auxiliary information projected in the display region.

FIG. 10 is a flowchart showing Example Operation 1 performed by the display device according to the embodiment.

FIG. 11 is a flowchart showing Example Operation 2 performed by the display device according to the embodiment.

FIG. 12 is a flowchart showing Example Operation 3 performed by the display device according to the embodiment.

FIG. 13 is a flowchart showing Example Operation 4 performed by the display device according to the embodiment.

### DESCRIPTION OF EMBODIMENT

Hereinafter, a certain exemplary embodiment is described in greater detail with reference to the accompanying Drawings. The exemplary embodiment described below shows a general or specific example. The numerical values, shapes, materials, elements, the arrangement and connection of the elements, steps, the processing order of the steps, etc. shown in the following exemplary embodiment are mere examples, and therefore do not limit the scope of the present disclosure. Among the elements in the following exemplary embodiment, those not recited in any one of the independent claims are described as optional elements.

Note that the drawings are schematic diagrams, and are not always strictly drawn. In the drawings, the same reference signs are assigned to substantially the same configurations, and overlapping descriptions may be omitted or simplified.

### Embodiment 1

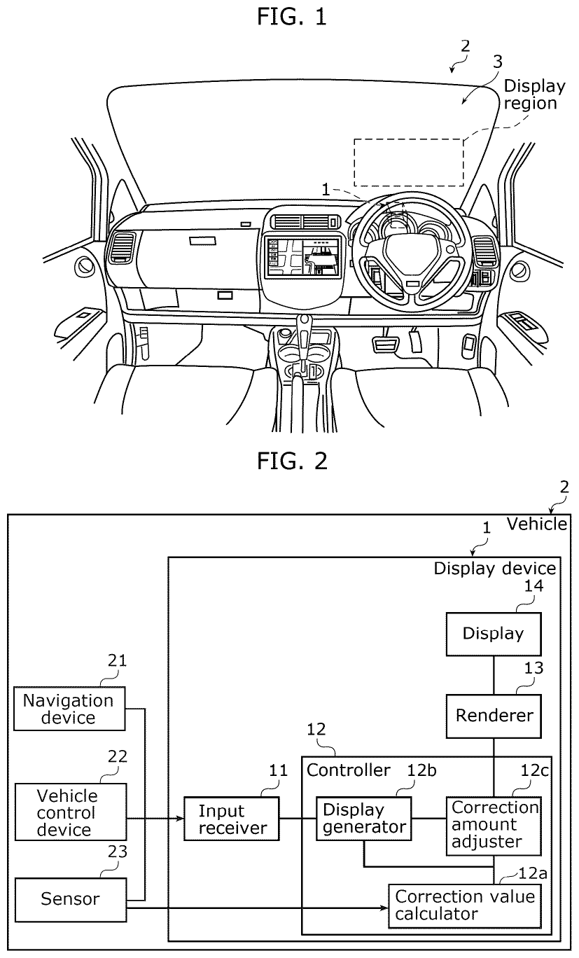

First, with reference to FIG. 1 through FIG. 3, the following describes display device 1, a display method, and a program of the present embodiment.

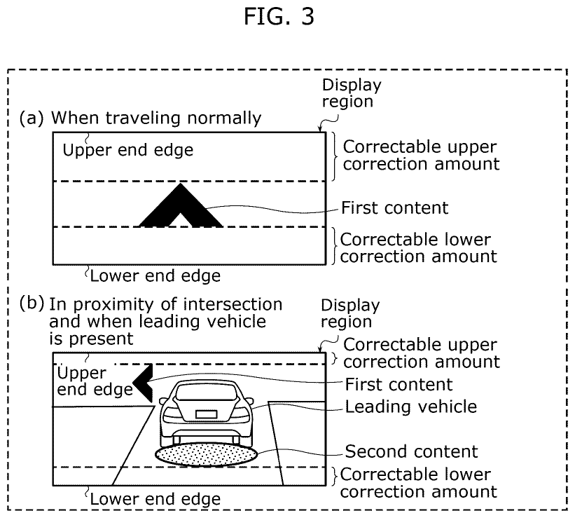

FIG. 1 is a diagram showing the vehicle chamber of vehicle 2 in which display device 1 according to the present embodiment is disposed. FIG. 2 is a block diagram showing vehicle 2. FIG. 3 is a diagram showing contents to be projected in a display region and correctable correction amounts of the contents.

### <Functional Configuration>

As shown in FIG. 1 and FIG. 2, display device 1 is, for example, an HUD that is mounted on vehicle 2. Display device 1 is capable of emitting display light, which is light representing a content, toward the display region of display medium 3 having transmission properties, and causing the display light to be reflected at the display region of display medium 3, thereby enabling the display light to enter the user's eyes. When used in vehicle 2, for example, display device 1 is capable of enabling the display light to enter the user's eyes by causing the display light that is emitted toward the display region of display medium 3 (e.g., a transmissive front window or a transmissive combiner) to be reflected. This enables the user to three-dimensionally view the display light as a virtual image, while recognizing the actual image the user is seeing through the display region of display medium 3.

The display light is light for three-dimensionally displaying a virtual image, which is an image, onto display medium 3. The image is a still image or a moving image, and an image showing a numeric character, a text, graphics, etc.

Display device 1 determines the display mode of the display light to be projected toward the display region of display medium 3, on the basis of information from each of a plurality of devices mounted on vehicle 2.

The plurality of devices include, for example, navigation device 21, vehicle control device 22, and sensor 23.

Navigation device 21 is a navigation system mounted on vehicle 2. Using map data, navigation device 21 is capable of setting a scheduled route, which is an optimum route on which vehicle 2 is scheduled to travel from the current position to the destination. Navigation device 21 is also capable of, for example, proving the user with information such as road traffic information about the surroundings and setting a scheduled route changed by the user in accordance with the road traffic information about the surroundings. Navigation device 21 outputs, to display device 1, vehicle-related information including the scheduled route that has been set. The scheduled route, which is a route on which vehicle 2 is scheduled to travel, is displayed, for example, as a virtual image (content to be described later) that is overlaid on a target object seen through the display region of display medium 3. Examples of the target object include a road, an intersection, a traffic marking, a road sign, or other objects placed on the road.

Vehicle control device 22 is a device for performing various controls relating to the traveling of vehicle 2. For example, vehicle control device 22 controls the revolutions of the engine, and controls the transmission, the revolutions of the engine, the braking system, etc. in accordance with a driver's operation and the traveling situation. Vehicle control device 22 outputs, to display device 1, vehicle-related information including various controls relating to the traveling of vehicle 2.

Sensor 23 is mounted on vehicle 2. Sensor 23 is an in-vehicle sensor such as: a camera sensor that detects the surrounding environment including the presence/absence of a target object around vehicle 2, the shape of a road, etc.; a distance sensor that detects the distance from vehicle 2 to the target object; a speed sensor that detects the traveling speed of vehicle 2; an acceleration senor that detects the acceleration of vehicle 2; and a steering angle sensor that detects the angle of steering. Sensor 23 outputs, to display device 1, vehicle-related information including the surrounding environment, the distance from vehicle 2 to the target object, the traveling speed of vehicle 2, the acceleration of vehicle 2, the steering angle of vehicle 2, etc.

Display device 1 includes input receiver 11, controller 12, renderer 13, and display 14.

Input receiver 11 is an input interface for obtaining the vehicle-related information outputted by each of the plurality of devices. Input receiver 11 outputs the obtained items of vehicle-related information to controller 12. Input receiver 11 may also be capable of outputting the items of vehicle-related information to correction value calculator 12a.

As shown in FIG. 2, controller 12 is capable of determining at least one content to be displayed in association with a target object that is present in the forward view of vehicle 2. Controller 12 adjusts, for each content, the correction amount relating to the placement position of the content. Controller 12 is further capable of adjusting the correction amount in accordance with the relation between the placement position of the content displayed in the display region of display medium 3 and the position of the target object that is seen through the display region.

More specifically, controller 12 includes correction value calculator 12a, display generator 12b, and correction amount adjuster 12c.

Correction value calculator 12a may be capable of obtaining the vehicle-related information via input receiver 11 and/or directly from sensor 23. FIG. 2 shows an example case where correction value calculator 12a obtains the vehicle-related information directly from sensor 23.

Correction value calculator 12a calculates the amount of misalignment from the target object that is present in the forward view of vehicle 2 to a content, on the basis of one or more items of the vehicle-related information obtained.

For example, when vehicle 2 travels on a road, there can occur the case where the sway of vehicle 2 causes a misalignment of the placement position of a content to be projected toward the display region of display medium 3 from the position of a target object that is present in the forward view of vehicle 2. It is thus desired that the content is placed to show (indicate) the target object of interest even when vehicle 2 sways. For this reason, to correct the misalignment caused by the sway of vehicle 2, correction value calculator 12a calculates a misalignment correction value that is based on the amount of the misalignment. When the content is misaligned from the target object due to a change in the attitude angle caused by the sway of vehicle 2 that is traveling, for example, correction value calculator 12a determines the attitude angle of vehicle 2 from the vehicle-related information from sensor 23, and calculates a correction value, that is, a misalignment correction value, in accordance with the angle of the misalignment. Stated differently, the misalignment correction value is a correction value for interpolating the misalignment of the content from the target object. The misalignment correction value is calculated on a content-by-content basis. Correction value calculator 12a outputs the calculated misalignment correction value of each content to display generator 12b and/or correction amount adjustor 12c. In the present embodiment, correction value calculator 12a outputs the calculated misalignment correction value to display generator 12b.

Display generator 12b generates each content, on the basis of one or more items of the vehicle-related information obtained by input receiver 11, and determines the display mode of the generated content. More specifically, on the basis of one or more items of the vehicle-related information obtained, display generator 12b generates at least one content that corresponds to the target object which is present in the forward view of vehicle 2, determines a content to be displayed on display 14, and determines the display mode of each of at least one content.

A content, which is displayed in association with the target object that is present in the forward view of vehicle 2, is an image (display object) that is displayed onto display medium 3 as a virtual image by means of display light. For example, at least one content includes a first content, a second content, a third content, and a fourth content. In the present embodiment, the first content, the second content, the third content, and the fourth content are also collectively referred to simply as “contents”.

The first content is a content for showing the traveling direction on the basis of the scheduled route of vehicle 2. For example, the first content is a content for navigation guidance for guiding the driver along the scheduled route. The first content is in the form of an arrow, an index finger mark, etc. Stated differently, the shape of the first content may be another known shape with which the guidance can be provided to the driver.

The second content is a content for showing, as a target object, a leading vehicle that is present in the forward view of vehicle 2. For example, the second content is a content relating to adaptive cruise control (ACC), which is the function of assisting vehicle 2 to follow the leading vehicle that is traveling ahead of vehicle 2. For example, the second content is in a circular shape, a polygonal shape, etc. Stated differently, the shape of the second content may be another known shape that indicates a target object.

The third content is a content for showing a mobile object that is present in the forward view of vehicle 2. For example, the third content is a content relating to pedestrian collision warning (PCW), which is the function of warning that vehicle 2 is at a high risk of contacting or colliding with a mobile object such as a pedestrian, a vehicle, etc., in accordance with the distance between the mobile object and vehicle 2. For example, the third content is in the form of a balloon, a sign, etc. indicating the presence of a mobile object. Stated differently, the shape of the third content may be another known shape that indicates a mobile object.

The fourth content is a content for showing a lane on a road on which vehicle 2 travels. For example, the fourth content is a content relating to lane departure warning (LDW), which is the function of warning the driver by means of warning display, warning sound, vibration, etc., when vehicle 2 has strayed from the lane or is likely to stray from the lane due to, for example, drowsy driving, inattentive driving, etc. For example, the fourth content shows road markings including: a regulatory marking indicating a side strip, a vehicular lane, etc. of the road on which vehicle 2 travels; and an indicator marking indicating a halfway line, a crosswalk, a stop line, a traffic lane line, etc. of the road on which vehicle 2 travels. The shape of the fourth content may be another known shape that indicates a lane.

Upon determining the display mode of the generated content, display generator 12b outputs the determined display mode of the content to correction amount adjuster 12c. For example, display generator 12b generates at least one content in accordance with the scheduled route indicated by the vehicle-related information from navigation device 21, and determines the display mode of each of at least one content generated.

The display mode of a content is determined, for example, in accordance with a guidance route, a target object that is present around vehicle 2, the distance between the target object and vehicle 2, the traveling speed of vehicle 2, etc. The display mode of a content includes the type of the target object, the placement position of the content, the number of contents displayed together, the size of the content, the speed at which the content is changed, etc.

With this, display generator 12b outputs, to correction amount adjuster 12c, at least one content determined and the display mode of each of at least one content.

Correction amount adjuster 12c at least obtains, from display generator 12b, at least one content determined and the display mode of each of at least one content.

Correction amount adjuster 12c calculates the correction amount from the placement position of the content displayed in the display region in accordance with the content determined by display generator 12b. Also, correction amount adjuster 12c adjusts the calculated correction amount from the relation between the placement position of the content displayed in the display region and the position of the target object that is seen through the display region, in accordance with the content determined by display generator 12b. Correction amount adjuster 12c calculates and adjusts a correctable correction amount by which the placement position of a content can be corrected (hereinafter also referred to as “correctable correction amount”) on a content-by-content basis. Note that the correction amount may be adjusted not only for each content, but also for each content type. Stated differently, the correction amount may be adjusted in unit of content type. Thus, in the present embodiment, “for each content” may be also read as “for each content type”. Also, a content type may be any one of the first content to the fourth content, or may be the type for each function indicated by a content.

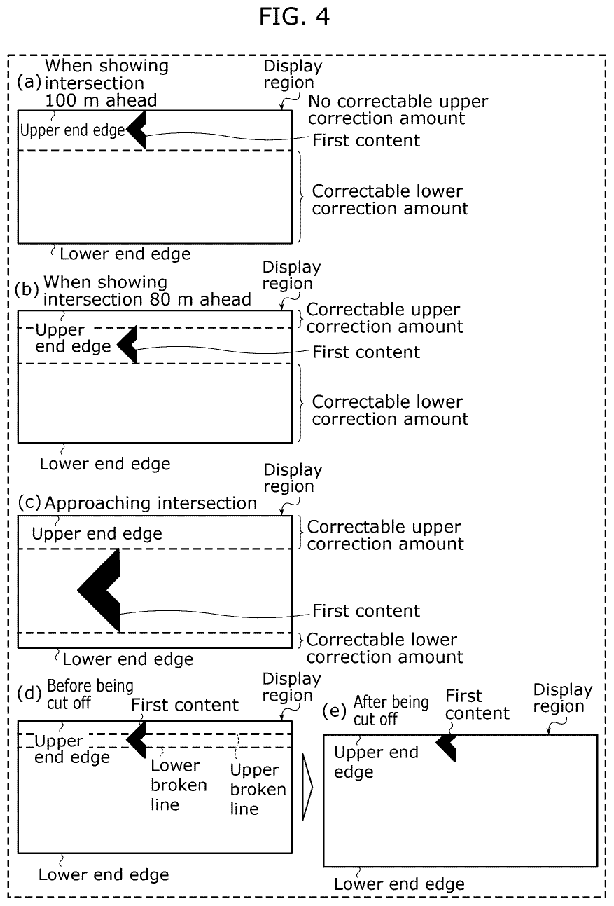

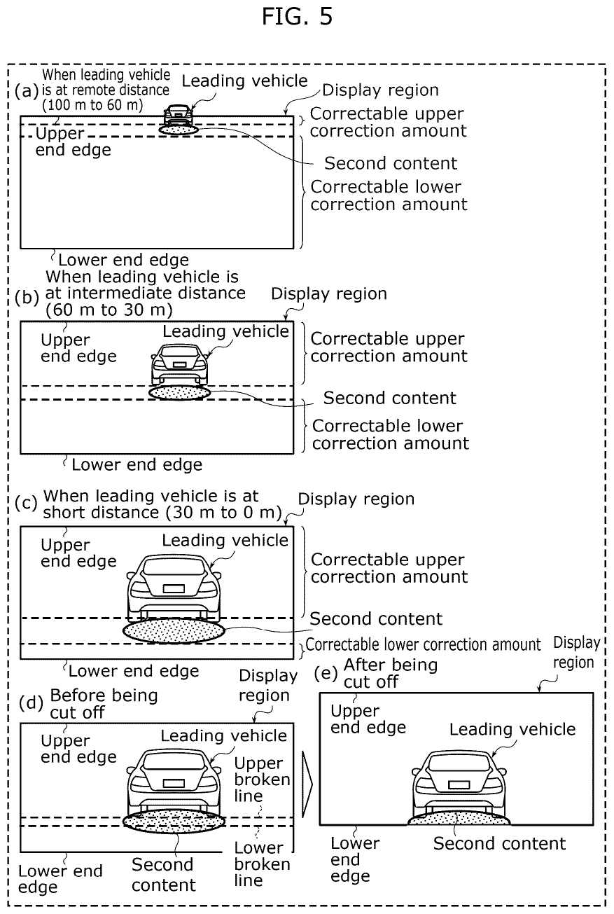

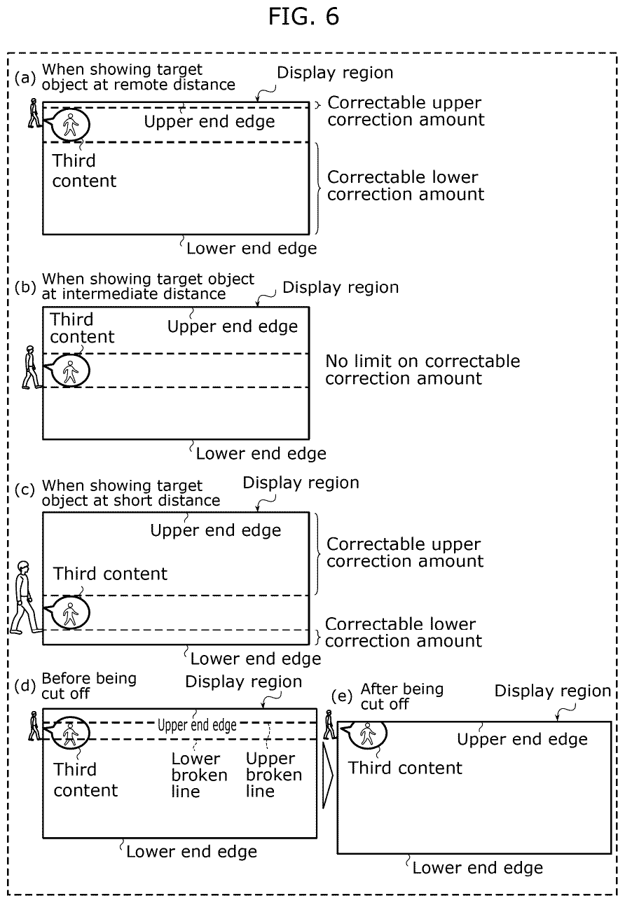

As shown in (a) in FIG. 3, when a content displayed in the display region is a content in the form of an arrow indicating the traveling direction on the road on which vehicle 2 travels normally, for example, correction amount adjuster 12c sets a correctable upper correction amount whose upper limit is between the broken line that contacts the upper end of the content and the upper end edge of the display region, and adjusts the correctable upper correction amount in accordance with the amount of misalignment. Similarly, correction amount adjuster 12c sets a correctable lower correction amount whose upper limit is between the broken line that contacts the lower end of the content and the lower end edge of the display region, and adjusts the correctable lower correction amount in accordance with the amount of misalignment. Note that in (a) and (b) in FIG. 3, the broken lines are shown to describe the present embodiment, and thus are not displayed in the display region. The same is applicable to the broken lines shown in (a) through (c) in FIG. 4, (a) through (c) in FIG. 5, and (a) through (c) in FIG. 6.

Also, in (b) in FIG. 3, the first content and the second content are displayed in the display region, when vehicle 2 is present in proximity of an intersection and the leading vehicle is present ahead of vehicle 2, where the first content is a content in the form of an arrow showing the traveling direction on the road in which vehicle 2 turns in proximity of the intersection and the second content is a content showing the leading vehicle as a target object. At this time, correction amount adjuster 12c may adjust the correction amount of each of the first content and the second content. For the first content, for example, correction amount adjuster 12c may adjust the correctable upper correction amount whose upper limit is between the broken line that contacts the upper end of the first content and the upper end edge of the display region, in accordance with the first content. For the second content, for example, correction amount adjuster 12c may adjust the correctable lower correction amount whose upper limit is between the broken line that contacts the lower end of the second content and the lower end edge of the display region, in accordance with the second content.

Also, correction amount adjuster 12c may extract the smallest correction amount from the correctable correction amount of the first content and the correctable correction amount of the second content, and adjust the other of the correction amounts to the extracted correction amount. When the correction amount between the broken line that contacts the upper end of the first content and the upper end edge of the display region is small, for example, correction amount adjuster 12c may correct the correctable lower correction amount whose upper limit is between the broken line that contacts the lower end of the second content to the lower end edge of the display region to cause the correctable lower correction amount to be equal to the foregoing smallest correction amount.

Note that a specific example of content adjustment on the basis of the correction amount is described in detail later.

Correction amount adjuster 12c outputs, to renderer 13, the correction amount of each content adjusted in accordance with the content.

Renderer 13 obtains the content and the display mode of the content determined by controller 12 and the correction amount adjusted in accordance with the content, and renders the content in accordance with the adjusted correction amount. More specially, on the basis of each content and the display mode of the content obtained from display generator 12b via correction amount adjuster 12c, and the correction amount for the content obtained from correction amount adjuster 12c, renderer 13 renders the content in accordance with the display mode of the content for the content to be projected from display 14 onto display medium 3.

For example, renderer 13 controls the size of the content, the shape of the content, the color of the content, the brightness of the content, etc. in accordance with the determined display mode of the content. Further, in consideration of the correction amount of each content, renderer 13 renders the content using the correction amount for the content. Renderer 13 outputs the rendering result to display 14.

Display 14 is a projector that projects light representing a content determined by controller 12 onto display medium 3 provided in vehicle 2. More specifically, display 14 projects, onto display medium 3 provided in vehicle 2, light (display light) representing the content in the display mode determined by controller 12, on the basis of the rendering result obtained from renderer 13. The display light projected onto display medium 3 is reflected at display medium 3 toward the user in vehicle 2. As such, display 14 displays the content, which is the display light, as a virtual image through display medium 3. This enables the user to view the content, as a virtual image, which is displayed through display medium 3.

Here, in some cases, display generator 12b determines the display mode of each content, on the basis of the misalignment correction value calculated by correction value calculator 12a, to correct the placement position of each of contents.

In this case, display generator 12b generates auxiliary information that is generated for each content. It is possible to add auxiliary information to each content determined by display generator 12b.

In the case where auxiliary information is added to each content, it is also possible for display generator 12b to output, to correction amount adjuster 12c, the contents determined, the items of auxiliary information, and the display modes of the contents to which the items of auxiliary information are added.

When the auxiliary information is added to each content, correction amount adjuster 12c can obtain, directly from correction value calculator 12a or via display generator 12b, the contents determined, the items of auxiliary information, and the display modes of the contents to which the items of auxiliary information are added.

Correction amount adjuster 12c calculates the correction amount from the placement position of each content displayed in the display region, in accordance with the content determined by display generator 12b.

Renderer 13 renders each content in accordance with the display mode of the content to project the content from display 14 to display medium 3, on the basis of: the contents, the items of auxiliary information, the display modes of the contents to which the items of auxiliary information are added, which are obtained from display generator 12; and the correction amounts for the contents obtained from correction amount adjuster 12c. Renderer 13 outputs, to display 14, the rendering result, which is the contents to which the items of auxiliary information are added.

### <Content Adjustment>

Next, with reference to FIG. 4 through FIG. 9, the following describes content adjustment that is performed in display device 1, the display method, and the program in the present embodiment, on the basis of the correction amount.

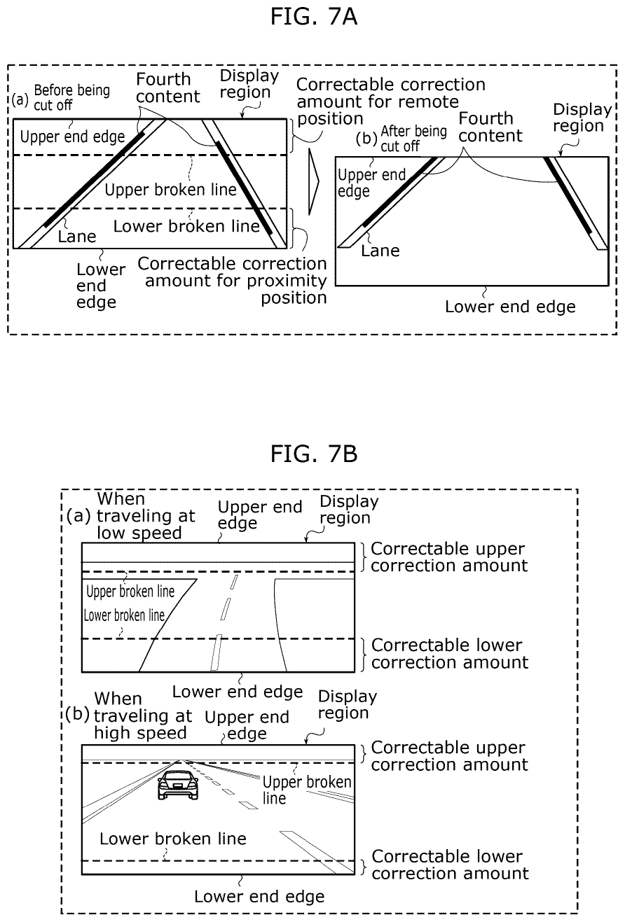

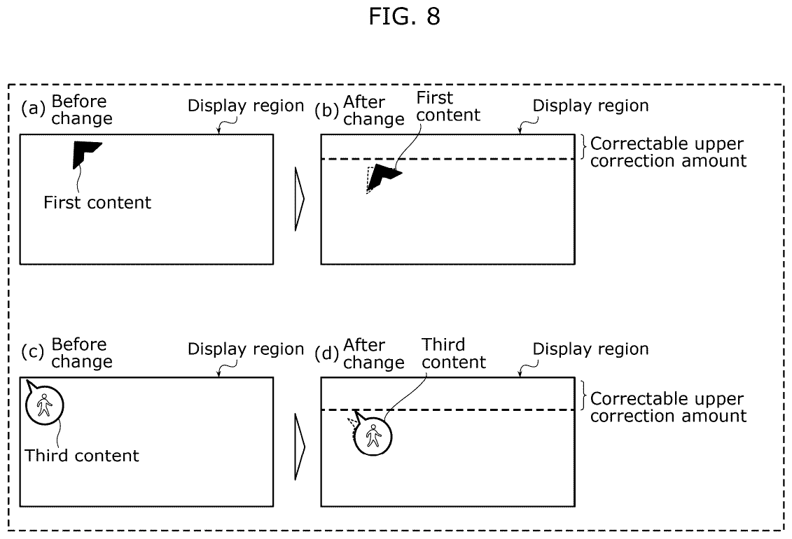

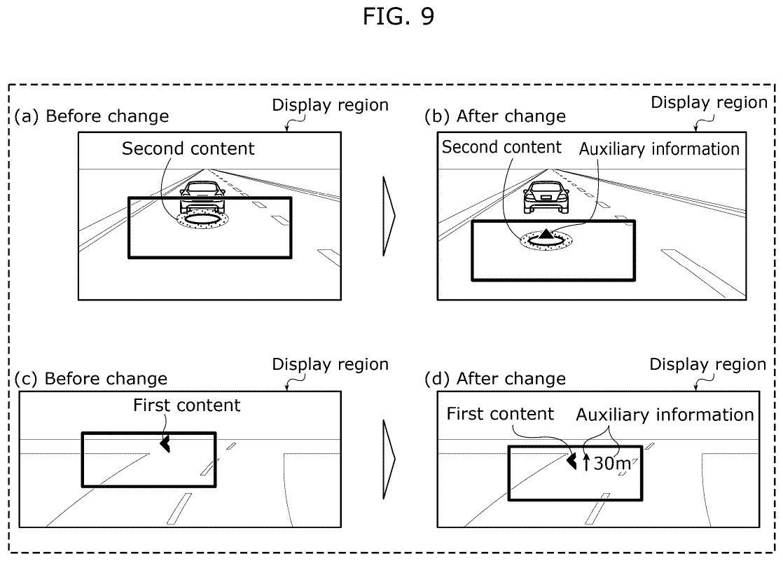

FIG. 4 is a diagram showing the first content projected in the display region and correctable correction amounts that are responsive to the placement position of the first content. FIG. 5 is a diagram showing the second content projected in the display region and correctable correction amounts that are responsive to the placement position of the second content. FIG. 6 is a diagram showing the third content projected in the display region and correctable correction amounts that are responsive to the placement position of the third content. FIG. 7A is a diagram showing the fourth content projected in the display region and correctable correction amounts that are responsive to the placement position of the fourth content. FIG. 7B is a diagram showing the fourth content projected in the display region and correctable correction amounts that are responsive to the placement position of the fourth content, when vehicle 2 is traveling at a low speed and at a high speed. FIG. 8 is a diagram showing a manner in which the orientations of contents projected in the display region are changed. FIG. 9 is a diagram showing contents and auxiliary information projected in the display region.

First, controller 12 is capable of adjusting the correction amount in accordance with the distance from vehicle 2 to the target object. More specifically, controller 12 is capable of, for example, adjusting the correction sensitivity and the upper limit of the correction amount to make the correction range between the upper side of the display region and the upper end of a content narrower as the distance from vehicle 2 to the target object is longer. Controller 12 is also capable of, for example, adjusting the correction sensitivity and the upper limit of the correction amount to make the correction range between the lower side of the display region and the lower end of the content narrower as the distance from vehicle 2 to the target object is shorter.

For example, (a) in FIG. 4 assumes the case where an intersection is present in a remote position that is on the order of 100 m ahead of vehicle 2. In this case, the first content is placed on the upper side of the display region, and no gap (the width in the up-down direction) is present between the upper end of the first content and the upper end edge of the display region. Thus, no correctable correction amount is substantially present above the first content. However, a gap (the width in the up-down direction) is formed between the lower end of the first content and the lower end edge of the display region, and thus a correctable correction amount is present below the first content.

(b) in FIG. 4 assumes the case where an intersection is present in a remote position that is on the order of 80 m ahead of vehicle 2. In this case, the first content is placed on the upper side of the display region, and a slight gap is formed between the upper end of the first content and the upper end edge of the display region. Thus, a correctable correction amount is slightly present above the first content. A gap is formed between the lower end of the first content and the lower end edge of the display region, and thus a correctable correction amount is present below the first content.

(c) in FIG. 4 assumes the case where vehicle 2 is approaching an intersection. In this case, the first content is largely placed in the central portion of the display region, and a gap is formed between the upper end of the first content and the upper end edge of the display region. A slight gap is formed between the lower end of the first content and the lower end edge of the display region. As such, a correctable correction amount is present above the first content, and a correctable correction amount is slightly present below the first content.

As in the foregoing cases, display generator 12b determines the display mode of the first content in accordance with the distance from vehicle 2 to the intersection (target object) that is based on the vehicle-related information from sensor 23. Correction amount adjuster 12c adjusts the correction amount as the correction sensitivity relating to the placement position of the first content whose display mode has been determined.

With this, it is possible to display the entirety of the first content in the display region to cause the first content to be responsive to the target object even when vehicle 2 sways.

As described above, the adjustment of the correction amount includes the adjustment of the correction sensitivity of a content to cause the entirety of the content to be displayed in the display region.

Also, when a content is the first content for displaying the traveling direction on the road, controller 12 is further capable of adjusting the upper limit of the correction amount in accordance with the distance from vehicle 2 to the target object to cause at least the tip shown by the first content to be displayed within the display region of display medium 3.

(d) in FIG. 4 shows the first content before being cut off, and (e) in FIG. 4 shows the first content after being cut off. (d) and (e) in FIG. 4 assume the case where an intersection is present in a remote position that is on the order of 100 m ahead of vehicle 2. The present embodiment allows the first content to be partially cut off even when vehicle 2 sways. In the case where the cut-off is not allowed, the entirety of the first content remains placed on the upper end edge of the display region, as a result of which the first content fails to show the target object appropriately, when vehicle 2 sways.

In view of this, in the present embodiment, correction amount adjuster 12c sets the correction amount to be smaller than the width of the first content in the up-down direction, as shown in (d) in FIG. 4, to cause at least the tip portion of the first content showing the traveling direction to be displayed in the display region. Correction amount adjuster 12c adjusts the upper limit of the upper correction amount in the display region, thereby forming a slight gap between the upper broken line and the upper end edge of the display region. Correction amount adjuster 12c adjusts the correction amount relating to the placement position of the first content whose upper limit, which ranges between the upper broken line and the upper end edge of the display region, has been changed. Note that in (d) and (e) in FIG. 4, the upper broken lines and the lower broken lines, which are shown for controlling the upper limit of the correction amount to decrease the width of the first content in the up-down direction, are intended to describe the present embodiment, and thus are not displayed in the display region. The same is applicable to the upper broken lines and the lower broken lines shown in (d) and (e) in FIG. 5, (d) and (e) in FIG. 6, FIG. 7A, FIG. 7B, and FIG. 8.

Note that the correction amount whose upper limit has been changed to allow the cut-off of a content may be preliminarily set and recorded in memory provided in display device 1, or may be calculated by correction amount adjuster 12c whenever necessary in accordance with the placement position of the content and depending on content, etc.

With this, it is possible to display at least part of the first content in the display region, as shown in (e) in FIG. 4, to cause the first content to be responsive to the target object even when vehicle 2 sways.

As described above, the adjustment of the correction amount further includes changing the upper limit of the correction amount to allow a content to be partially cut off in the display region. Note that to “allow a content to be partially cut off” means that part of the content is displayed to an extent to which the content can be recognized, and thus does not mean that simply part of the content is displayed. The same is applicable to the description below.

Note that in (d) and (e) in FIG. 4, the upper limit of the upper correction amount in the display region is changed to form a slight gap between the upper broken line and the upper end edge of the display region, but the same is applicable to the case where the upper limit of the lower correction amount in the display region is changed to form a slight gap between the lower broken line and the lower end edge of the display region.

Next, controller 12 is capable of adjusting the correction amount in accordance with the distance from vehicle 2 to the target object. More specifically, controller 12 is further capable of, for example, adjusting the correction sensitivity and the upper limit of the correction amount in accordance with the distance between the leading vehicle shown by the second content and vehicle 2. Controller 12 is also capable of, for example, adjusting the correction sensitivity and the upper limit of the correction amount in accordance with the distance between the leading vehicle shown by the second content and vehicle 2 to cause at least part of the second content to be displayed within the display region of display medium 3.

For example, (a) in FIG. 5 assumes the case where the leading vehicle (target object) is present at a remote distance that is on the order of 100 m to 60 m from vehicle 2. In this case, the second content is placed on the upper side of the display region, and a slight gap is formed between the upper end of the second content and the upper end edge of the display region. Thus, a correctable correction amount above the second content is small. However, a large gap is formed between the lower end of the second content and the lower end edge of the display region, and thus a correctable correction amount is present below the second content.

(b) in FIG. 5 assumes the case where the leading vehicle is present at an intermediate distance that is on the order of 60 m to 30 m from vehicle 2. In this case, the second content is placed in the central portion of the display region, and a gap is formed between the upper end of the second content and the upper end edge of the display region. Thus, a correctable correction amount is present above the second content. A gap is formed between the lower end of the second content and the lower end edge of the display region, and thus a correctable correction amount is present below the second content.

(c) in FIG. 5 assumes the case where the leading vehicle is present at a short distance that is on the order of 30 m to 0 m from vehicle 2. In this case, the second content is largely placed in the central portion of the display region, and a gap is formed between the upper end of the second content and the upper end edge of the display region. Thus, a correctable correction amount is present above the second content. A slight gap is formed between the lower end of the second content and the lower end edge of the display region, and thus a correctable correction amount is slightly present below the second content.

As in the foregoing cases, display generator 12b determines the display mode of the second content in accordance with the distance from vehicle 2 to the leading vehicle that is based on the vehicle-related information from sensor 23. Correction amount adjuster 12c adjusts the correction amount relating to the placement position of the second content whose display mode has been determined.

With this, it is possible to display the entirety of the second content in the display region to cause the second content to be responsive to the target object even when vehicle 2 sways.

Also, when a content is the second content for displaying the leading vehicle, controller 12 is further capable of adjusting the correction amount in accordance with the distance from vehicle 2 to the target object to cause at least part of the second content to be displayed within the display region of display medium 3.

(d) in FIG. 5 shows the second content before being cut off, and (e) in FIG. 5 shows the second content after being cut off. (d) and (e) in FIG. 5 assume the case where the leading vehicle is present at a short distance from vehicle 2. The present embodiment allows the second content to be partially cut off even when vehicle 2 sways. In the case where the cut-off of the second content is not allowed, the entirety of the second content remains placed on the lower end edge of the display region, as a result of which the second content fails to show the target object appropriately when vehicle 2 sways.

In view of this, in the present embodiment, correction amount adjuster 12c sets the correction amount to be smaller than the width of the second content in the up-down direction, as shown in (d) in FIG. 5, to cause at least part of the second content showing the leading vehicle to be displayed in the display region. For example, correction amount adjuster 12c adjusts the upper limit of the lower correction amount in the display region, thereby forming a larger gap between the lower broken line and the lower end edge of the display region. Correction amount adjuster 12c adjusts the correction amount relating to the placement position of the second content whose upper limit, which ranges between the lower broken line and the lower end edge of the display region, has been changed.

With this, it is possible to display at least part of the second content in the display region, as shown in (e) in FIG. 5, to cause the second content to be responsive to the target object even when vehicle 2 sways.

Note that, in (d) and (e) in FIG. 5, the upper limit of the lower correction amount in the display region is changed to form a slight gap between the lower broken line and the lower end edge of the display region, but the same is applicable to the case where the upper limit of the upper correction amount in the display region is changed to form a slight gap between the upper broken line and the upper end edge of the display region.

Next, controller 12 is capable of adjusting the correction amount, that is, a correction sensitivity, in accordance with the distance between a mobile object shown by the third content and vehicle 2. Controller 12 is also capable of adjusting the upper limit of the correction amount in accordance with the distance between the mobile object shown by the third content and vehicle 2 to cause at least part of the third content to be displayed within the display region of display medium 3.

For example, (a) in FIG. 6 assumes the case where a mobile object (target object), which is a pedestrian, is present at a remote distance from vehicle 2. In this case, the third content is placed on the upper side of the display region, and a slight gap is formed between the upper end of the third content and the upper end edge of the display region. Thus, a correctable correction amount above the third content is small. However, a large gap is formed between the lower end of the third content and the lower end edge of the display region, and thus a correctable correction amount is present below the third content.

(b) in FIG. 6 assumes the case where a mobile object is present at an intermediate distance from vehicle 2. In this case, the third content is placed in the central portion of the display region, and a gap is formed between the upper end of the third content and the upper end edge of the display region, and a gap is formed between the lower end of the third content and the lower end edge of the display region. As shown in (b) in FIG. 6, no correctable correction amount may be set and no limit may be placed on the correction amount. For example, when a correctable correction amount is greater than or equal to a predetermined value, no limit may be also placed on the correctable correction amount. This is applicable to the cases shown in the other diagrams. Also, a correctable correction amount may be set above the third content, and a correctable correction amount may be set below the third content.

(c) in FIG. 6 assumes the case where a mobile object is present at a short distance from vehicle 2. In this case, the third content is largely placed in the central portion of the display region, and a gap is formed between the upper end of the third content and the upper end edge of the display region. Thus, a correctable correction amount is present above the third content. A slight gap is formed between the lower end of the third content and the lower end edge of the display region, and thus a correctable correction amount is slightly present below the third content.

As in the foregoing cases, display generator 12b determines the display mode of the third content in accordance with the distance from vehicle 2 to the mobile object that is based on the vehicle-related information from sensor 23. Correction amount adjuster 12c adjusts the correction amount relating to the placement position of the third content whose display mode has been determined.

With this, it is possible to display the entirety of the third content in the display region to cause the third content to be responsive to the mobile object even when vehicle 2 sways.

Also, when a content is the third content for showing a mobile object that is present in the forward view, controller 12 is further capable of adjusting the correction amount in accordance with the distance from vehicle 2 to the mobile object to cause at least part of the third content to be displayed within the display region of display medium 3.

(d) in FIG. 6 shows the third content before being cut off, and (e) in FIG. 6 shows the second content after being cut off. (d) and (e) in FIG. 6 assume the case where a mobile object is present at a remote distance from vehicle 2. The present embodiment allows the third content to be partially cut off even when vehicle 2 sways. In the case where the cut-off is not allowed, the entirety of the third content remains placed on the upper side of the display region, as a result of which the third content fails to show the mobile object appropriately when vehicle 2 sways.

In view of this, in the present embodiment, correction amount adjuster 12c sets the correction amount to be smaller than the width of the third content in the up-down direction, as shown in (d) in FIG. 6, to cause at least part of the third content showing the mobile object to be displayed in the display region. For example, correction amount adjuster 12c adjusts the upper limit of the upper correction amount in the display region, thereby forming a larger gap between the upper broken line and the upper end edge of the display region. Correction amount adjuster 12c adjusts the correction amount relating to the placement position of the third content whose upper limit, which ranges between the upper broken line and the upper end edge of the display region, has been changed.

With this, it is possible to display at least part of the third content in the display region, as shown in (e) in FIG. 6, to be the third content is responsive to the mobile object even when vehicle 2 sways.

Note that, in (d) and (e) in FIG. 6, the upper limit of the upper correction amount in the display region is changed to form a slight gap between the upper broken line and the upper end edge of the display region, but the same is applicable to the case where the upper limit of the lower correction amount in the display region is changed to form a slight gap between the lower broken line and the lower end edge of the display region.

Next, when a content is the fourth content for showing a road marking that represents a lane, controller 12 is capable of adjusting the upper limit of the correction amount in accordance with the distance between the lane, which is the target object shown by the fourth content, and vehicle 2 to cause at least part of the fourth content to be displayed within the display region of display medium 3.

(a) in FIG. 7A shows the fourth content before being cut off, and (b) in FIG. 7A shows the fourth content after being cut off. (a) and (b) in FIG. 7A assume the case where a lane extending from a remote distance to a short distance from vehicle 2 is present. The present embodiment allows the fourth content to be partially cut off even when vehicle 2 sways. In the case where the cut-off is not allowed, the entirety of the fourth content is misaligned in the display region, as a result of which the fourth content fails to show the lane appropriately when vehicle 2 sways.

In view of this, in the present embodiment, correction amount adjuster 12c sets the correction amount to be smaller than the width of the fourth content in the up-down direction, as shown in (d) in FIG. 7A, to cause at least part of the fourth content showing the lane to be displayed in the display region. For example, correction amount adjuster 12c adjusts the upper limit of the upper correction amount in the display region, thereby forming a larger gap between the upper broken line and the upper end edge of the display region. Correction amount adjuster 12c adjusts the correction amount relating to the placement position of the fourth content whose upper limit, which ranges between the upper broken line and the upper end edge of the display region, has been changed.

With this, it is possible to display at least part of the fourth content in the display region, as shown in (b) in FIG. 7A, to place the fourth content along the lane even when vehicle 2 sways.

Note that in FIG. 7A, the upper limit of the upper correction amount in the display region is changed to form a slight gap between the upper broken line and the upper end edge of the display region, but the same is applicable to the case where the upper limit of the lower correction amount in the display region is changed to form a slight gap between the lower broken line and the lower end edge of the display region.

Next, controller 12 is further capable of adjusting the correction amount in accordance with the traveling speed of vehicle 2. Controller 12 is further capable of adjusting the correction amount to be smaller as the traveling speed of vehicle 2 is higher.

As shown in (a) and (b) in FIG. 7B, as the traveling speed of vehicle 2 is higher, controller 12 may adjust the correctable correction amount to decrease a gap between the upper broken line and the upper end edge of the display region and a gap between the lower broken line and the lower end edge of the display region. For example, (a) in FIG. 7B shows vehicle 2 traveling on a non-highway road at a low speed, and (b) in FIG. 7B shows vehicle 2 traveling on a highway at a high speed.

Since the sway of vehicle 2 is less likely to be large as the traveling speed of vehicle 2 is higher, controller 12 adjusts the correctable correction amount to be smaller.

Next, controller 12 is further capable of adjusting the correction amount in accordance with the type of a road on which vehicle 2 travels. Roads on which vehicle 2 travels includes a highway and a non-highway road. When vehicle 2 travels on a highway, controller 12 is further capable of adjusting the correction amount to be smaller than the correction amount for case where vehicle 2 travels on a non-highway road.

On a highway, a misalignment is less likely to occur in a content that is overlaid onto a target object such as a branch point on a road shown by navigation guidance, and there are a larger number of content types than those for a non-highway road. An event for which the third content is displayed is less likely to occur such as PCW, which is the function of warning that vehicle 2 is at a high risk of contacting or colliding with a mobile object. For this reason, even when a correctable correction amount is adjusted to be small, it does not affect much.

Next, to display the content within the display region of display medium 3, controller 12 is capable of adjusting the orientation of a content more that is displayed in association with a target object as the distance from vehicle 2 to the target object is longer.

When a content is to be overlaid onto a target object in a remote position from vehicle 2, for example, there can occur the case where the cut-off of the content cannot be allowed, depending on the orientation of the content, when the tip of such content is present in proximity of the upper end edge of the display region or in proximity of the lower end edge of the display region. For this reason, it is desired that the position of the content is changed to avoid the cut-off of the content, with the content showing the target object in a remote position.

For example, (a) in FIG. 8 assumes the case where the first content shows a target object in a remote position. When the target object is a branch point such as a sharp intersection or a Y-shaped intersection, the first content basically indicates the upper side. In the case where the cut-off of the first content is not allowed, correction amount adjuster 12c moves the first content to the position indicated by the broken line where the first content can be corrected, as shown in (b) in FIG. 8, to secure a correctable correction amount that ranges from the first content to the upper end edge of the display region. Stated differently, to display the entirety of the first content in the display region, correction amount adjuster 12c moves the first content to the position where the orientation of the first content can be changed. Correction amount adjuster 12c then adjusts the orientation of the first content to cause the first content to be a content represented by the solid line and correctly show an intersection or a branch point. The orientation of the content includes the placement position of the content and the attitude of the content.

(c) in FIG. 8 assumes another example case where the third content shows a mobile object such as a pedestrian in a remote position. In this case, the third content basically indicates the upper side. In the case where the cut-off of the third content is not allowed, correction amount adjuster 12c moves the third content to the position indicated by the broken line where the third content can be corrected, as shown in (d) in FIG. 8, to secure a correctable correction amount that ranges from the third content to the upper end edge of the display region. Stated differently, to display the entirety of the third content in the display region, correction amount adjuster 12c moves the third content to the position where the orientation of the third content can be corrected. Correction amount adjuster 12c then adjusts the orientation of the third content to cause the third content to be a content represented by the solid line and correctly show the mobile object.

Next, controller 12 is capable of outputting, to display 14, an instruction for displaying auxiliary information together with a content, in the case where the placement position of the content has been corrected on the basis of the correction amount. The auxiliary information includes the direction from vehicle 2 to the target object and the distance from vehicle 2 to the target object. The direction from vehicle 2 to the target object is indicated by an arrow, and the distance from vehicle 2 to the target object is indicated by the color of the content, the shape of the content, or a numerical value.

When a misalignment correction value which is used to correct the amount of misalignment of the placement position of the second content shown in (b) in FIG. 9 is calculated from the state in which the second content is displayed as shown in (a) in FIG. 9, for example, display generator 12b adds auxiliary information together with the second content, on the basis of the misalignment correction value for the placement position of the content. For the auxiliary information, too, for example, correction amount adjuster 12c adjusts the correctable correction amount and correction value calculator 12a calculates the misalignment correction value. Renderer 13 renders the auxiliary information, and display 14 displays such auxiliary information in the display region together with the second content. The auxiliary information in (b) FIG. 9 indicates the direction from vehicle 2 to the target object in the form of an arrow.

When the placement position of the first content is corrected as shown in (d) in FIG. 9 from the state in which the first content is displayed as shown in (c) in FIG. 9, for example, display generator 12b adds the auxiliary information to the first content. The auxiliary information in (d) in FIG. 9 is indicated as the direction from vehicle 2 to the target object (upward-pointing arrow) and as “30 m”, which is the distance from vehicle 2 to the target object.

Note that when the distance from vehicle 2 to the target object is indicated by the color of the content, for example, the distance may be indicated by darker red as the distance from vehicle 2 is shorter, and by darker blue as the distance from vehicle 2 is longer. The shape of the content may be a shape that is longer in the left-right direction as the distance from vehicle 2 is shorter, and a shape that is longer in the up-down direction as the distance from vehicle 2 is longer.

Note that the numerical value, the colors, the shapes, etc. used to describe FIG. 9 above are mere examples, and thus the present embodiment is not limited these examples. As such, any known numerical value, color, shape, etc. may be used.

### Example Operation 1

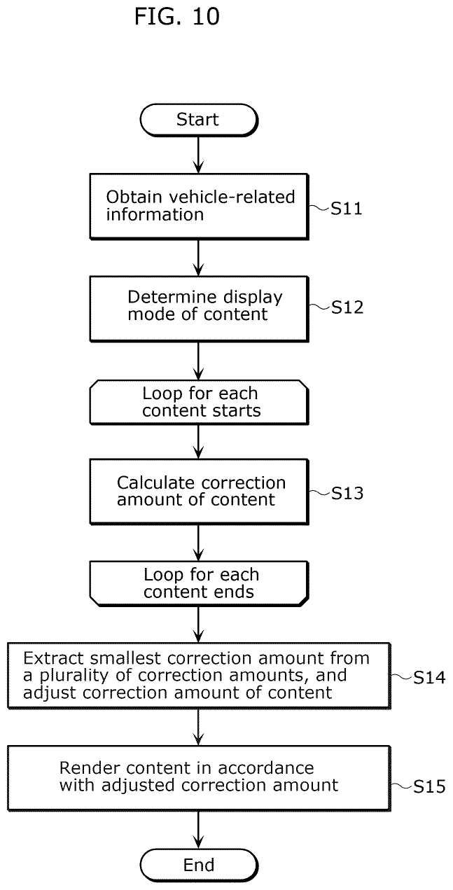

Next, with reference to FIG. 10, the following describes an example operation performed by display device 1, the display method, and the program in the present embodiment. In FIG. 10, an example operation is described for the case shown in (a), (b), and (c) in FIG. 4, (a), (b), and (c) in FIG. 5, and (a), (b), and (c) in FIG. 6 where the correction amount of each content is adjusted in accordance with the content.

FIG. 10 is a flowchart showing Example Operation 1 performed by display device 1 according to the embodiment.

First, input receiver 11 obtains the vehicle-related information outputted by each of a plurality of devices (S11). Input receiver 11 outputs the obtained items of vehicle-related information to display device 1.

Next, display generator 12b obtains the items of vehicle-related information obtained by input receiver 11 of display device 1, generates at least one content on the basis of the items of vehicle-related information, and determines the display mode of each of at least one content generated (S12). Upon determining the display mode of the generated content, display generator 12b outputs the generated content and the determined display mode of the content to correction amount adjuster 12c.

Next, correction amount adjuster 12c calculates the correction amount by which the content can be corrected. Stated differently, correction amount adjuster 12c calculates a correctable correction amount of each content from the content and the display mode of the content determined by display generator 12b (S13). Correction amount adjuster 12c repeats step S13 for each content determined by display generator 12b, in accordance with the content.

Next, correction amount adjuster 12c adjusts the correction amount from the relation between the placement position of each content displayed in the display region and the position of a target object that is seen through the display region.

More specifically, correction amount adjuster 12c extracts the smallest correction amount from at least one correction amount calculated on a content-by-content basis for at least one content obtained. Correction amount adjuster 12c then adjusts the correction amount of each content determined by display generator 12b to the smallest correction amount extracted (S14). Correction amount adjuster 12c outputs, to renderer 13, at least one content determined by display generator 12b, the display mode of each of at least one content, and the correction amount of each of at least one content adjusted in accordance with the content.

Note that in step S14 in FIG. 10, correction amount adjuster 12c extracts the smallest correction amount from correction amounts and adjusts the correction amounts of all contents to the smallest correction amount extracted, but the present embodiment is not limited to this. Correction amount adjuster 12c may adjust, for each content, the correction amount in accordance with the content as described above.

Next, to project each content from display 14 onto display medium 3, renderer 13 renders the content in accordance with the display mode of the content, on the basis of the content and the display mode of the content obtained from display generator 12b via correction amount adjuster 12c, and the correction amount of the content obtained from correction amount adjuster 12c. Stated differently, renderer 13 renders each content in accordance with the determined display mode and the adjusted correction amount (S15). Display 14 projects light representing the content (display light) onto display medium 3, on the basis of the rendering result of renderer 13, thereby displaying the content represented by the display light as a virtual image through display medium 3. This enables the user to view each content displayed through display medium 3 as a virtual image.

Then, the example operation shown in FIG. 10 ends.

### Example Operation 2

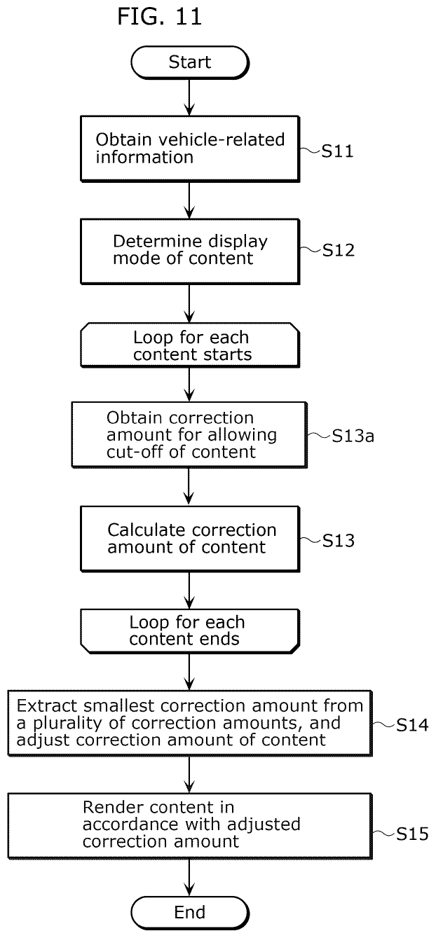

Next, with reference to FIG. 11, the following describes an example operation performed by display device 1, the display method, and the program in the present embodiment. In FIG. 11, an example operation is described for the case shown in (d) and (e) in FIG. 4, (d) and (e) in FIG. 5, (d) and (e) in FIG. 6, and (a) and (b) in FIG. 7A where the cut-off of a content is allowed.

FIG. 11 is a flowchart showing Example Operation 2 performed by display device 1 according to the embodiment.

In the present example operation, the same reference signs are assigned to the same processes as those in Example Operation 1, and the descriptions for the same processes are omitted as appropriate.

First, after steps S11 and S12, correction amount adjuster 12c obtains the correction amount for allowing the cut-off of a content (S13a). Stated differently, correction amount adjuster 12c obtains the correction amount whose upper limit has been changed.

Correction value calculator 12a repeats steps S13a and S13 for each content determined by display generator 12b, in accordance with the content.

Then, after steps S14 and S15, the example operation shown in FIG. 11 ends.

### Example Operation 3

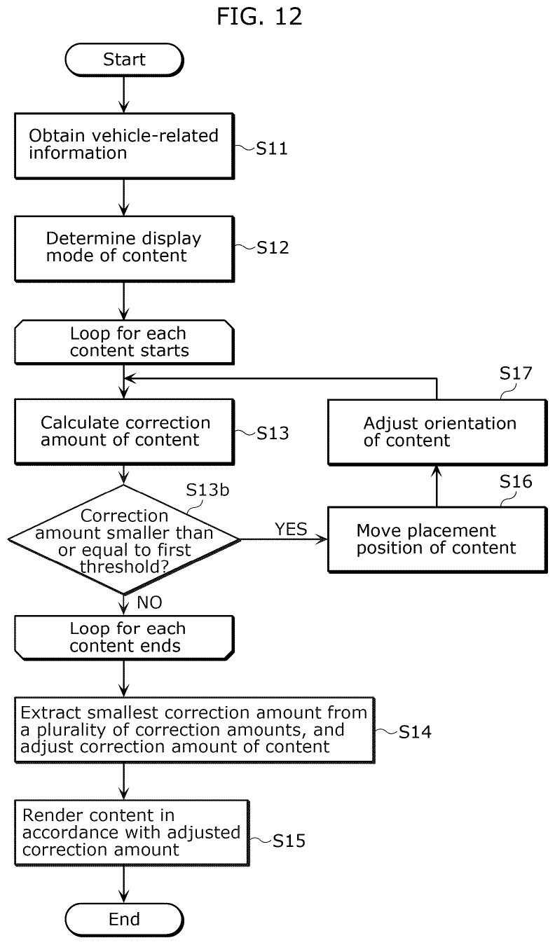

Next, with reference to FIG. 12, the following describes an example operation performed by display device 1, the display method, and the program in the present embodiment. In FIG. 12, an example operation is described for the case shown in FIG. 8 where the cut-off of a content is not allowed.

FIG. 12 is a flowchart showing Example Operation 3 performed by display device 1 according to the embodiment.

In the present example operation, the same reference signs are assigned to the same processes as those in Example Operation 1, and the descriptions for the same processes are omitted as appropriate.

First, after steps S11 through S13, correction amount adjuster 12c determines whether the calculated correction amount of the content is smaller than or equal to a first threshold (S13b). When the correction amount of the content is smaller than or equal to the first threshold, the content is partially cut off. For this reason, correction amount adjuster 12c determines whether the calculated correction amount of the content is adjusted to a correction amount that does not cause the cut-off of the content.

When correction amount adjuster 12c determines that the calculated correction amount of the content is smaller than or equal to the first threshold (YES in S13b), correction value calculator 12a moves the content to a position where the content can be corrected and adjusts the correction amount to place the content in the near side (S16). With this, it is possible to increase the correction amount relating to the placement position of the content.

Next, correction amount adjuster 12c adjusts the orientation of the content to cause the content represented by the broken line shown in (b) and (d) in FIG. 8 to be a content represented by the solid line and correctly show the target object (S17). Then, the example operation performed by display device 1 proceeds to step S13.

Also, correction value calculator 12a repeats steps S13, S13b, S16, and S17 for each content determined by display generator 12b, in accordance with the content.

Meanwhile, when correction amount adjuster 12c determines that the calculated correction amount of the content is less than the first threshold (NO in S13b), the example operation shown in FIG. 12 ends after steps S14 and S15.

### Example Operation 4

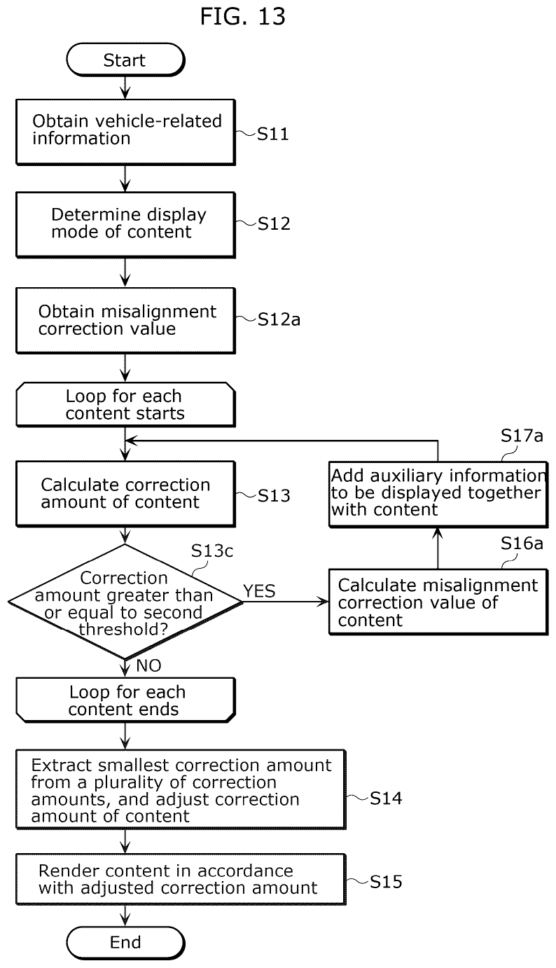

Next, with reference to FIG. 13, the following describes an example operation performed by display device 1, the display method, and the program in the present embodiment. In FIG. 13, an example operation is described for the case shown in FIG. 9 where the amount of misalignment in the placement position of a content is corrected.

FIG. 13 is a flowchart showing Example Operation 4 performed by display device 1 according to the embodiment.

In the present example operation, the same reference signs are assigned to the same processes as those in Example Operation 1, and the descriptions for the same processes are omitted as appropriate.

First, after steps S11 and S12, correction amount adjuster 12c obtains the misalignment correction value of the content calculated by correction value calculator 12a (S12a).

After step S13, correction amount adjuster 12c determines whether the calculated misalignment correction value of the content is greater than or equal to a second threshold (S13c).

When correction amount adjuster 12c determines that the calculated misalignment correction value of the content is greater than or equal to the second threshold (YES in S13c), correction value calculator 12a calculates a misalignment correction value, which is the amount of misalignment in the placement position of the content (S16a). Correction value calculator 12a outputs the calculated misalignment correction value to display generator 12b.

Next, display generator 12b generates auxiliary information that is based on the misalignment correction value of the placement position of the content. Display generator 12b adds the auxiliary information generated in accordance with the content (S17a). Display generator 12b adds auxiliary information to each content, and outputs, to correction amount adjuster 12c, the content, the auxiliary information, and the display mode of the content to which the auxiliary information is added. Then, the example operation performed by display device 1 proceeds to step S13.

Steps S13, S13c, S16a, and S17a are repeated for each content determined by display generator 12b, in accordance with the content.

Meanwhile, when correction amount adjuster 12c determines that the calculated misalignment correction value of the content is less than the second threshold (NO in S13c), the example operation shown in FIG. 13 ends after steps S14 and S15.

### <Working Effects>

The following describes the working effects of display device 1, the display method, and the program according to the present embodiment.

For example, in the display control device disclosed in PTL 1, the misalignment of the placement position of a content is corrected to a reduced extent depending on content, when the angle of view of the HUD is narrow. This causes a problem that the misalignment of the placement position of the content cannot be sufficiently corrected.

However, as described above, display device 1 in a first aspect according to the present embodiment includes: controller 12 that determines at least one content to be displayed in association with a target object that is present in a forward view of vehicle 2; and display 14 that displays the at least one content as a virtual image through display medium 3 provided in vehicle 2 by projecting, onto display medium 3, light that represents the at least one content determined by controller 12. Here, controller 12 adjusts, for each of the at least one content, a correction amount relating to a placement position of the content.

With this, it is possible to adjust the correction amount relating to the placement position of the content displayed on display medium 3. This enables the target object shown by the content to be displayed, even when some kind of sway occurs in vehicle 2 while vehicle 2 is traveling. Also, since the correction amount is corrected for each content, it is possible to indicate the target object that corresponds to the content.

Thus, according to the present disclosure, it is possible to adjust the correction amount of each content to a correction amount appropriate to the content.

Also, display device 1 in a second aspect according to the present embodiment is display device 1 according to the first aspect. In this case, controller 12 further adjusts the correction amount in accordance with a relation between the placement position of the content displayed in a display region of display medium 3 and a position of the target object that is seen through the display region.

With this, it is possible to adjust the correction amount in accordance with the relation between the placement position of the content and the position of the target object that is seen through the display region. This enables the content to be placed to show the target object.

Also, display device 1 in a third aspect according to the present embodiment is display device 1 according to the second aspect. In this case, controller 12 adjusts the correction amount to make a correction range narrower as a distance from vehicle 2 to the target object is longer, the correction range being a range between an upper side of the display region and an upper end of the content.

With this, it is possible to place the content close to the upper end edge of the display region, even when the target object is present in a remote position from vehicle 2. This enables the content to be placed to show the target object that appears through display medium 3, even when vehicle 2 sways while traveling.

Also, display device 1 in a fourth aspect according to the present embodiment is display device 1 according to the second aspect or the third aspect. In this case, controller 12 adjusts the correction amount to make a correction range narrower as a distance from vehicle 2 to the target object is shorter, the correction range being a range between a lower side of the display region and a lower end of the content.

With this, it is possible to place the content close to the lower end edge of the display region, even when the target object is present in proximity of vehicle 2. This enables the content to be placed to show the target object that appears through display medium 3, even when vehicle 2 sways while traveling.

Also, display device 1 in a fifth aspect according to the present embodiment is display device 1 according to any one of the first aspect to the third aspect. In this case, controller 12 further adjusts the correction amount in accordance with a distance from vehicle 2 to the target object.

With this, it is possible to adjust the correctable correction amount to a correction amount that suits the distance from vehicle 2 to the target object. Stated differently, when the distance from vehicle 2 to the target object is long, the content is displayed in a small size on the upper side of the display region, and when the distance from vehicle 2 to the target object is short, the content is displayed in a large size in the central portion of the display region. Accordingly, it is possible to appropriately place the content in the display region in accordance with the distance from vehicle 2 to the target object.

Also, display device 1 in a sixth aspect according to the present embodiment is display device 1 according to any one of the first aspect to the fifth aspect. In this case, when the at least one content is a first content for showing a traveling direction on a road, controller 12 further adjusts the correction amount in accordance with a distance from vehicle 2 to the target object to cause at least a tip to be displayed within a display region of display medium 3, the tip being shown by the first content.

With this, even when the first content is partially cut off, it is possible for the user to recognize the target object shown by the first content, because the tip shown by the first content is displayed in the display region.

Also, by partially cutting off the first content, it is possible to keep displaying the target object shown by the first content in an appropriate manner, even when vehicle 2 sways while traveling.

Also, display device 1 in a seventh aspect according to the present embodiment is display device 1 according to any one of the first aspect to the sixth aspect. In this case, the at least one content includes a second content for showing, as the target object, a leading vehicle traveling ahead of vehicle 2. The target object includes the leading vehicle. Controller 12 further adjusts the correction amount in accordance with a distance between the leading vehicle shown by the second content and vehicle 2.

With this, it is possible to adjust the correctable correction amount to be a correction amount that suits the distance from vehicle 2 to the leading vehicle. Stated differently, when the distance from vehicle 2 to the leading vehicle is long, the second content is displayed in a small size on the upper side of the display region, and when the distance from vehicle 2 to the leading vehicle is short, the second content is displayed in a large size on the lower side of the display region. Accordingly, it is possible to appropriately place the second content in the display region in accordance with the distance from vehicle 2 to the leading vehicle.

Also, display device 1 in an eighth aspect according to the present embodiment is display device 1 according to the seventh aspect. In this case, controller 12 adjusts the correction amount in accordance with the distance between the leading vehicle shown by the second content and vehicle 2 to cause at least part of the second content to be displayed within a display region of display medium 3.

With this, even when the second content is partially cut off, it is possible for the user to recognize the target object shown by the second content, because the remaining part of the second content is partially displayed in the display region.

Also, by partially cutting off the second content, it is possible to keep displaying the target object shown by the second content in an appropriate manner, even when vehicle 2 sways while traveling.

Also, display device 1 in a ninth aspect according to the present embodiment is display device 1 according to any one of the first aspect to the eighth aspect. In this case, the at least one content includes a third content for showing a mobile object that is present in the forward view. Here, controller 12 adjusts the correction amount in accordance with a distance between the mobile object shown by the third content and vehicle 2.

With this, it is possible to adjust the correctable correction amount to be a correction amount that suits the distance from vehicle 2 to the mobile object. Stated differently, when the distance from vehicle 2 to the mobile object is long, the third content is displayed in a small size on the upper side of the display region, and when the distance from vehicle 2 to the mobile object is short, the third content is displayed in a large size on the lower side of the display region. Accordingly, it is possible to appropriately place the third content in the display region in accordance with the distance from vehicle 2 to the mobile object.

Also, display device 1 in a tenth aspect according to the present embodiment is display device 1 according to the ninth aspect. In this case, controller 12 adjusts the correction amount in accordance with the distance between the mobile object shown by the third content and vehicle 2 to cause at least part of the third content to be displayed within a display region of display medium 3.

With this, even when the third content is partially cut off, it is possible for the user to recognize the mobile object shown by the third content, because the remaining part of the third content is partially displayed in the display region.

Also, by partially cutting off the third content, it is possible to keep displaying the mobile object shown by the third content in an appropriate manner, even when vehicle 2 sways while traveling.

Also, display device 1 in an eleventh aspect according to the present embodiment is display device 1 according to any one of the first aspect to the tenth aspect. In this case, the at least one content includes a fourth content for showing a lane. Here, controller 12 adjusts the correction amount in accordance with a distance between the target object shown by the fourth content and vehicle 2 to cause at least part of the fourth content to be displayed within a display region of display medium 3.

With this, even when the fourth content is partially cut off, it is possible for the user to recognize the lane shown by the fourth content, because the remaining part of the fourth content is partially displayed in the display region.

Also, by partially cutting off the fourth content, it is possible to keep displaying the lane shown by the fourth content in an appropriate manner, even when vehicle 2 sways while traveling.

Also, display device 1 in a twelfth aspect according to the present embodiment is display device 1 according to any one of the first aspect to the eleventh aspect. In this case, controller 12 further adjusts the correction amount in accordance with a traveling speed of vehicle 2.

With this, it is possible to adjust the correction amount in accordance with the traveling speed of vehicle 2. Since the content is adjusted using the correction amount that is responsive to the speed, it is possible to keep displaying the target object shown by the content in an appropriate manner, even when vehicle 2 sways while traveling.

Also, display device 1 in a thirteenth aspect according to the present embodiment is display device 1 according to the twelfth aspect. In this case, controller 12 further adjusts the correction amount to be smaller as the traveling speed of vehicle 2 is higher. With this, it is possible to decrease the correction amount that is a range within which the correction amount is correctable, because the sway of vehicle 2 is likely to be smaller as the traveling speed of vehicle 2 is higher. It is also possible to increase the correction amount that is a range within which the correction amount is correctable, because the sway of vehicle 2 is likely to be greater as the traveling speed of vehicle 2 is slower.

Since the content is adjusted using the correction amount that is responsive to the speed, it is possible to keep displaying the target object shown by the content in an appropriate manner, even when vehicle 2 sways while traveling.

Also, display device 1 in a fourteenth aspect according to the present embodiment is display device 1 according to any one of the first aspect to the thirteenth aspect. In this case, controller 12 further adjusts the correction amount in accordance with a type of a road on which vehicle 2 travels.

With this, it is possible to adjust the correction amount in accordance with the road on which vehicle 2 travels. Since the content is adjusted using the correction amount that is responsive to the road type, it is possible to keep displaying the target object shown by the content in an appropriate manner, even when vehicle 2 sways while traveling.

Also, display device 1 in a fifteenth aspect according to the present embodiment is display device 1 according to the fourteenth aspect. In this case, the road on which vehicle 2 travels includes a highway and a non-highway road. When vehicle 2 travels on the highway, controller 12 further adjusts the correction amount to be smaller than a correction amount for a case where vehicle 2 travels on the non-highway road.

With this, when vehicle 2 travels on a highway, for example, it is possible for controller 12 to further adjust the correction amount to be smaller than the correction amount for the case where vehicle 2 travels on a non-highway road. Further, when vehicle 2 travels on a non-highway road, for example, it is possible for controller 12 to adjust the correction amount to be greater than the correction amount for the case where vehicle 2 travels on a highway.

Also, display device 1 in a sixteenth aspect according to the present embodiment is display device 1 according to any one of the first aspect to the fifteenth aspect. In this case, to display the at least one content within a display region of display medium 3, controller 12 adjusts an orientation of the at least one content more, as a distance from vehicle 2 to the target object is longer, the at least one content being displayed in association with the target object.

With this, when the target object is in a remote position from vehicle 2, controller 12 adjusts the orientation of the content. It is thus possible for the content to keep showing the target object in an appropriate manner, even when the cut-off of the content is not allowed.

Also, display device 1 in a seventeenth aspect according to the present embodiment is display device 1 according to any one of the first aspect to the sixteenth aspect. In this case, controller 12 includes correction value calculator 12a that calculates a misalignment correction value that is a value for correcting a misalignment from the target object that is present in the forward view of vehicle 2 to the at least one content. Here, controller 12 outputs, to display 14, an instruction for displaying auxiliary information together with the at least one content, when the placement position of the at least one content has been corrected based on the misalignment correction value.

With this, it is possible to display the auxiliary information in the display region, when the placement position of the content has been corrected. This enables the user to understand a change in the content. Accordingly, it is possible for the user to understand the target object shown by the content and have a secure feeling regarding a change in the content.

Also, display device 1 in an eighteenth aspect according to the present embodiment is display device 1 according to any one of the first aspect to the seventeenth aspect. In this case, the auxiliary information includes a direction from vehicle 2 to the target object and a distance from vehicle 2 to the target object.

With this, it is possible to display, in the display region, the direction from vehicle 2 to the target object and the distance from vehicle 2 to the target object. This enables the user to recognize the direction from vehicle 2 to the target object and the distance from vehicle 2 to the target object.

Also, display device 1 in a nineteenth aspect according to the present embodiment is display device 1 according to the eighteenth aspect. In this case, the direction from vehicle 2 to the target object is indicated by an arrow. The distance from vehicle 2 to the target object is indicated by a color of the at least one content, a shape of the at least one content, or a numerical value.

With this, it is possible to display, in the display region, the direction from vehicle 2 to the target object and the distance from vehicle 2 to the target object in a manner that is easy for the user to recognize. This enables the user to more easily recognize the direction from vehicle 2 to the target object and the distance from vehicle 2 to the target object.

Also, display device 1 in a twentieth aspect according to the present embodiment is display device 1 according to any one of the first aspect to the nineteenth aspect. In this case, controller 12 extracts a smallest correction amount from a plurality of correction amounts of contents, and adjusts remaining one or more of the plurality of correction amounts to the smallest correction amount extracted, the plurality of correction amounts each being the correction amount, the contents being the at least one content.

With this, it is possible to adjust the other correction amounts to adjust the correction amounts to the smallest correction amount from the plurality of correction amounts. This enables controller 12 to collectively adjust the correction amounts of contents, and adjust the correction amounts of all contents to be appropriate correction amounts.

Also, a display method in a twenty-first aspect according to the present embodiment includes: determining at least one content to be displayed in association with a target object that is present in a forward view of a vehicle, the determining being performed by controller 12; displaying the at least one content as a virtual image through display medium 3 provided in vehicle 2 by projecting, onto display medium 3, light that represents the at least one content determined by controller 12; and adjusting a correction amount relating to a placement position of each of the at least one content, using a correction amount appropriate to the content, the adjusting being performed by controller 12.

Such display method also achieves the same working effects as those described above.

Also, a program in a twenty-second aspect according to the present embodiment is a program capable of causing a computer to execute the display method according to the twenty-first aspect.

Such program also achieves the same working effects as those described above.

### [Other Variations]

The display device, the display method, and the program according to the present disclosure have been described above on the basis of the foregoing embodiment, but the present disclosure is not limited to the foregoing embodiment. The scope of the present disclosure may also include an embodiment achieved by making various modifications to the embodiment that can be conceived by those skilled in the art without departing from the essence of the present disclosure.

For example, the controller, the renderer, the display, etc. included in the display device, the display method, and the program according to the foregoing embodiment are implemented in the form of an LSI, which is typically an integrated circuit. These elements may be individually integrated into a single chip, or may be integrated into a single chip to encompass these elements in whole or in part.

Also, the circuit integration is not limited to the implementation in the form of an LSI, and thus each of the elements may be implemented in the form of an exclusive circuit or a general-purpose processor. A field programmable gate array (FPGA) that allows for programming after the manufacture of an LSI, or a reconfigurable processor that allows for reconfiguration of the connection and the settings of circuit cells inside an LSI may be used.

Each of the elements in the foregoing embodiment may be configured in the form of an exclusive hardware product, or may be realized by executing a software program suitable for the element. Each of the elements may be realized by means of a program executing unit, such as a CPU and a processor, reading and executing the software program recorded on a recording medium such as a hard disk or a semiconductor memory.

Also, the division of the functional blocks in the block diagram is an example, and thus a plurality of functional blocks may be implemented in the form of a single functional block, a single functional block may be divided into a plurality of blocks, and some of the functions may be moved to another functional block. Also, the functions of a plurality of functional blocks having similar functions may be processed by single hardware or software in parallel or in a time-shared manner.

Also, the order of executing the steps in each of the flowcharts is intended to specifically illustrate the present disclosure, and thus may be an order other than the foregoing order. Also, some of the steps may be executed simultaneously with other steps (in parallel).

Note that the present disclosure also includes an embodiment achieved by making various modifications to the foregoing embodiment that can be conceived by those skilled in the art, and an embodiment achieved by freely combining some of the elements and functions in the foregoing embodiment without departing from the essence of the present disclosure.

### Further Information about Technical Background to this Application

The disclosures of the following patent applications including specification, drawings, and claims are incorporated herein by reference in their entirety: Japanese Patent Application No. 2023-170156 filed on Sep. 9, 2023

### INDUSTRIAL APPLICABILITY

The present disclosure is applicable for use as, for example, a display device that is mounted on a vehicle.

1. A display device comprising:
a controller that determines at least one content to be displayed in association with a target object that is present in a forward view of a vehicle; and
a display that displays the at least one content as a virtual image through a display medium provided in the vehicle by projecting, onto the display medium, light that represents the at least one content determined by the controller,
wherein the controller adjusts, for each of the at least one content, a correction amount relating to a placement position of the content.

2. The display device according to claim 1,
wherein the controller further adjusts the correction amount in accordance with a relation between the placement position of the content displayed in a display region of the display medium and a position of the target object that is seen through the display region.

3. The display device according to claim 2,
wherein the controller adjusts the correction amount to make a correction range narrower as a distance from the vehicle to the target object is longer, the correction range being a range between an upper side of the display region and an upper end of the content.

4. The display device according to claim 2,
wherein the controller adjusts the correction amount to make a correction range narrower as a distance from the vehicle to the target object is shorter, the correction range being a range between a lower side of the display region and a lower end of the content.

5. The display device according to claim 1,
wherein the controller further adjusts the correction amount in accordance with a distance from the vehicle to the target object.

6. The display device according to claim 1,
wherein when the at least one content is a first content for showing a traveling direction on a road, the controller further adjusts the correction amount in accordance with a distance from the vehicle to the target object to cause at least a tip to be displayed within a display region of the display medium, the tip being shown by the first content.

7. The display device according to claim 1,
wherein the at least one content includes a second content for showing, as the target object, a leading vehicle traveling ahead of the vehicle,
the target object includes the leading vehicle, and
the controller further adjusts the correction amount in accordance with a distance between the leading vehicle shown by the second content and the vehicle.

8. The display device according to claim 7,
wherein the controller adjusts the correction amount in accordance with the distance between the leading vehicle shown by the second content and the vehicle to cause at least part of the second content to be displayed within a display region of the display medium.

9. The display device according to claim 1,
wherein the at least one content includes a third content for showing a mobile object that is present in the forward view, and
the controller adjusts the correction amount in accordance with a distance between the mobile object shown by the third content and the vehicle.

10. The display device according to claim 9,
wherein the controller adjusts the correction amount in accordance with the distance between the mobile object shown by the third content and the vehicle to cause at least part of the third content to be displayed within a display region of the display medium.

11. The display device according to claim 1,
wherein the at least one content includes a fourth content for showing a lane, and
the controller adjusts the correction amount in accordance with a distance between the target object shown by the fourth content and the vehicle to cause at least part of the fourth content to be displayed within a display region of the display medium.

12. The display device according to claim 1,
wherein the controller further adjusts the correction amount in accordance with a traveling speed of the vehicle.

13. The display device according to claim 12,
wherein the controller further adjusts the correction amount to be smaller as the traveling speed of the vehicle is higher.

14. The display device according to claim 1,
wherein the controller further adjusts the correction amount in accordance with a type of a road on which the vehicle travels.

15. The display device according to claim 1,
wherein, to display the at least one content within a display region of the display medium, the controller adjusts an orientation of the at least one content more, as a distance from the vehicle to the target object is longer, the at least one content being displayed in association with the target object.

16. The display device according to claim 1,
wherein the controller includes a correction value calculator that calculates a misalignment correction value that is a value for correcting a misalignment from the target object that is present in the forward view of the vehicle to the at least one content, and
the controller outputs, to the display, an instruction for displaying auxiliary information together with the at least one content, when the placement position of the at least one content has been corrected based on the misalignment correction value.

17. The display device according to claim 16,
wherein the auxiliary information includes a direction from the vehicle to the target object and a distance from the vehicle to the target object.

18. The display device according to claim 1,
wherein the controller extracts a smallest correction amount from a plurality of correction amounts of contents, and adjusts remaining one or more of the plurality of correction amounts to the smallest correction amount extracted, the plurality of correction amounts each being the correction amount, the contents being the at least one content.

19. A display method comprising:
determining at least one content to be displayed in association with a target object that is present in a forward view of a vehicle, the determining being performed by a controller;
displaying the at least one content as a virtual image through a display medium provided in the vehicle by projecting, onto the display medium, light that represents the at least one content determined by the controller; and
adjusting a correction amount relating to a placement position of each of the at least one content, using a correction amount appropriate to the content, the adjusting being performed by the controller.

20. A non-transitory computer-readable recording medium having recorded thereon a program for causing a computer to execute the display method according to claim 19.
